(19) United States
(12) Patent Application Publication
(10) Pub. No.: US 2026/0045532 A1
(43) Pub. Date: Feb. 12, 2026

(54) APPARATUS FOR MAKING A COIL

(71) Applicant: G.D S.P.A., Bologna (IT)

(72) Inventors: Andrea BIONDI, Bologna (IT); Enrico CAMPAGNOLI, Bologna (IT); Luca CAVAZZA, Bologna (IT); Fabrizio NANNI, Bologna (IT)

(21) Appl. No.: 19/101,532

(22) PCT Filed: Jul. 28, 2023
(86) PCT No.: PCT/IB2023/057690

§ 371 Date: Feb. 5, 2025

(30) Foreign Application Priority Data
Aug. 5, 2022 (IT) 102022000016899

(51) Int. Cl. H01M 10/04

(52) U.S. Cl. CPC H01M 10/0409; H01M 10/0431

(57) ABSTRACT

Apparatus (100) for making a coil (B), preferably for an electrochemical cell intended for battery production, comprising a first confined zone (Z11) configured to operate at a first pressure (P11) and comprising at least one operating unit of the apparatus (100) for making a coil (B), and a first adjacent zone (Z2) and configured to operate at a second pressure (P2) and fluid-dynamically connected to the first confined zone (Z11). The first confined zone (Z11) is configured so as to operate in an overpressure condition (SP1) with respect to the first adjacent zone (Z2). A method is also described for making a coil (B), preferably for an electrochemical cell intended for battery production, the coil (B) being made by winding a strip-shaped article (N).

The present solution relates to an apparatus for making a coil, for example of the type formed by winding a strip-shaped article which includes a strip or a plurality of overlapped strips, preferably for an electrochemical cell intended for battery production.

The solution also concerns a method for making a coil, preferably for an electrochemical cell intended for battery production, the coil being made by winding a strip-shaped article.

The present solution finds a preferred, although not exclusive, application in the sector of the production of electrochemical cells, for the making of which a winding of a strip-shaped article is used.

In particular, in the relevant technical field, it is known to combine conductor and separator strips in layers in order to form an anode and cathode structure. The article made by overlapping the aforesaid layers is then wound in the form of a coil and used for making the electrochemical cell itself.

In general, apparatus for making coils for batteries operates in a controlled environment with a very low percentage of suspended particles (clean room), which in some cases or due to some of its parts also has extremely low relative humidity and low temperature (dry room).

For reasons of convenience and modularity of the apparatus, the different parts and devices may be comprised in separable, replaceable and independent/delimitable modules in order to provide a high degree of freedom of adaptability and modification for the user.

This approach relates to the need, especially for lithium-based materials that are exposed to detonation risks, to minimise the possibility of explosions during the process steps.

It is therefore clear that these technological measures arise from safety needs and purposes and are related to the possibility of undesirable chemical reactions between materials in the process environment.

In the present disclosure as well as in the herein enclosed claims, certain terms and expressions are deemed to have, unless otherwise expressly indicated, the meaning expressed in the following definitions.

The term “contaminating material” refers to solid and/or liquid and/or gaseous material present and/or produced in the zone of an apparatus for making a coil. Preferably, the contaminating material comprises, in particular, fine dust or powder.

The term “confined” refers to a zone spatially delimited through the use of one or more electronic devices and/or one or more physical elements (e.g. walls or air curtains) that nevertheless allow a fluid-dynamic exchange with at least one environment outside the delimited zone.

The term “fluid-dynamically connected”, and even more clearly the terms “fluid-dynamically connected when in use” refer to a condition in which there is an operational configuration between a first part and a second part of a system in which the fluid-dynamic transfer of material is made possible in an efficient manner.

In other words, in such a fluid-dynamically connected configuration when in use, it is possible to identify fluid paths that follow predetermined concentration or pressure gradients or fluid-dynamically imposed directions of travel.

The term “operating unit” refers to the set of one or more devices and/or one or more units of an apparatus for making a coil configured to perform at least one work step of a coil-making process.

The operating unit may comprise at least a part of a winding unit and/or a supply unit of the apparatus for making a coil.

The term “overpressure” associated with a particular zone of apparatus for making a coil means that this zone has a higher pressure condition, preferably average pressure, than another zone of said apparatus.

The term “depression” associated with a particular zone of apparatus for making a coil means that this zone has a lower pressure condition, preferably average pressure, than another zone of said apparatus.

The term “winding” is intended to mean making a spiral structure by rotation of a strip, a ribbon or more generally a strip-shaped article around an axis, a flat surface or another structure. By means of winding, the strip-shaped article will form one or more turns around the axis or structure.

The term “coil” is intended to mean any spiral structure formed by winding a strip, ribbon or more generally a strip-shaped article around an axis, a flat surface or another winding structure. Depending on the structure around which the strip-shaped article is wound, the overall shape of the coil may be substantially cylindrical rather than flattened or otherwise shaped.

The expression “substantially parallel”, in the context of the present invention, is intended to mean a possible deviation by ±15°, preferably ±10°, more preferably ±5° with respect to a perfect parallelism.

The Applicant has noted that it is useful to implement suction of dust and particulate material that is produced and/or released in zones where cleaning, ablation and/or handling of the surfaces of the strips are carried out.

In such cases, the Applicant has noted that it is useful to be able to create circumscribed zones of strong depression in order to quickly collect the material produced during these processes and to prevent the latter being able to move around in the environment as much as possible.

Additionally, the process steps of winding strips for batteries can proceed in a discontinuous manner with abrupt accelerations and decelerations that result in the production of local turbulent flows that further displace any dust produced.

The Applicant has perceived that it would be useful to be able to attempt to inhibit this dust circulation phase, particularly in cases where the applied extraction systems were insufficient to immediately or completely remove the particulate matter produced and circulating.

In addition, the Applicant noted that the winding zone is a particularly sensitive zone since the winding of the strip is carried out there in order to produce the final battery.

Further, the Applicant noted after several studies and approaches that it was interesting to take the opposite approach to the state of the art by creating an additional variation in the mobility of any dust present in the process environment. More specifically, the Applicant found that any dust present could be confined or moved into desired environments, preventing as much as possible it reaching more sensitive environments requiring specific levels of dust protection.

The Applicant therefore found it useful to be able to create an environmental condition of “macroscopic” flows in the environment that would prevent dust from reaching certain particularly critical zones of the apparatus.

The Applicant then defined a differentiation between different environments by classifying those that could tolerate higher levels of dust and others that were critically contaminated by unwanted dust.

In a first aspect thereof, therefore, the present solution concerns an apparatus for making a coil, preferably for an electrochemical cell intended for battery production.

Preferably, the apparatus for making a coil includes a first confined zone configured for operating at a first pressure.

Preferably, said first confined zone comprises at least one operating unit of said apparatus for making a coil.

Preferably, the apparatus for making a coil comprises a first adjacent zone configured to operate at a second pressure.

Preferably, the first adjacent zone is fluid-dynamically connected to said first confined zone.

Preferably, said first confined zone is configured in such a way that it operates in a condition of overpressure with respect to said first adjacent zone.

Said first pressure is therefore greater than said second pressure in said overpressure condition.

Thanks to these characteristics, it is possible to create an overpressure environment that prevents any contaminating material produced or otherwise present in another environment, i.e. in the first adjacent zone, from entering the first confined zone. Contaminating material, e.g. dust, that may be present in the first adjacent zone is therefore confined outside the first confined zone.

In a second aspect thereof, the present solution concerns a method for making a coil, preferably for an electrochemical cell intended for battery production.

Preferably the coil is made by winding a strip-shaped article.

Preferably, the method comprises arranging an apparatus for making a coil.

Preferably, said apparatus for making a coil comprises a first confined zone.

Preferably, said first confined zone comprises at least one operating unit of the apparatus for making a coil.

Preferably, the method comprises achieving an overpressure operating condition in said first confined zone with respect to a first adjacent zone.

Preferably said first adjacent zone is fluid-dynamically connected to said first confined zone so as to hinder the entry of contaminating material into said first confined zone from said first adjacent zone.

These characteristics ensure that the first confined zone is substantially free from contaminating material from the first adjacent zone.

In a third aspect thereof, the present solution concerns a further method for making a coil, preferably for an electrochemical cell intended for battery production.

Preferably the coil is made by winding a strip-shaped article.

Preferably, the method comprises arranging an apparatus for making a coil comprising an initial confined zone.

Preferably, said first confined zone comprises at least one operating unit of said apparatus for making a coil.

Preferably, said apparatus for making a coil comprises a first adjacent zone fluid-dynamically connected to said first confined zone.

Preferably, said method comprises achieving a depression operating condition in said first adjacent zone with respect to said first confined zone so as to hinder the entry of contaminating material into said first confined zone from said first adjacent zone and/or to ease the entry of contaminating material into said first adjacent zone from said first confined zone.

These features prove particularly useful in retaining any contaminating material present in the first adjacent zone.

In at least one of the aforesaid aspects, the present solution may also have at least one of the preferred features set out hereinafter.

Preferably, the first adjacent zone is fluid-dynamically connected, when in use, to said first confined zone.

In at least one embodiment of the present solution, said overpressure is greater than 0.1 mbar, preferably greater than 0.5 mbar, more preferably greater than 2 mbar.

In at least one embodiment of the present solution, said overpressure is comprised between 0.1 and 10 mbar, preferably between 0.3 and 5 mbar, more preferably between 0.5 and 3 mbar.

This generates a flow of air flowing from the first confined zone to the first adjacent zone such that the movement of contaminating material in the opposite direction, i.e. from the first adjacent zone to the first confined zone, is hindered.

In at least one embodiment of the present solution, the first adjacent zone is fluid-dynamically connected to the first confined zone by at least one opening arranged so as to define with said overpressure a flow of air, preferably substantially laminar, which through said opening having a speed greater than 0.1 m/s, preferably greater than 0.3 m/s, more preferably between 0.1 and 1 m/s, even more preferably comprised between 0.35 and 0.55 m/s.

Therefore, in this circumstance, the amount of airflow through the aforementioned opening section is such that the entry of contaminating material into the first confined zone from the first adjacent zone is hindered.

In at least one embodiment of the present solution, said apparatus for making a coil comprises a winding unit.

Preferably, said winding unit corresponds to said operating unit of said apparatus for making a coil.

Preferably, said winding unit includes at least one winding head configured to wind at least one strip-shaped article to make said coil.

Preferably, said winding unit is comprised within the first confined zone.

Preferably, said winding unit operates in said overpressure condition with respect to said first adjacent zone.

Thanks to these characteristics, the winding unit is substantially unaffected by any contaminating material that may be present in the first adjacent zone. The achievement of this goal is particularly appreciated in the sector to which this solution belongs since, generally speaking, it is particularly important to prevent contaminating material from being incorporated into a coil during the winding of at least one strip-shaped article.

Preferably, said winding unit includes a plurality of winding heads, each configured to wind at least one strip-shaped article so as to make a coil.

Preferably, the winding unit comprises a movement device of said at least one winding head configured to displace the at least one winding head along a working path.

In at least one embodiment of the present solution, said apparatus for making a coil comprises a feed unit.

Preferably, said feed unit is configured to feed a plurality of strips suitable for making said at least one strip-shaped article.

Preferably, said plurality of strips comprises at least one conductor strip and/or a separator strip.

Preferably, at least one conductive strips of said plurality of strips is an electrode and more preferably an anode.

Preferably, at least one conductive strips of said plurality of strips is an electrode and more preferably a cathode.

Preferably, at least one separator strip of said plurality of strips is an insulator and more preferably an electrical insulator.

Preferably, the electrical insulator is made of plastic.

Preferably, said plurality of strips comprises at least one anode and at least one cathode.

Preferably, said plurality of strips comprises at least one anode, at least one cathode and at least one separator strip.

Preferably, the feed unit comprises a movable portion which includes an outlet section through which said strip-shaped article passes when it exits said feed unit.

Said feed unit preferably comprises an outlet section through which said strip-shaped article is fed to said winding unit and, preferably, at least one inlet section.

Said at least one inlet section is preferably adapted to receive said at least one strip from a respective dispensing device.

Preferably respective feed paths are defined for each of said strips.

Said feed paths preferably comprise a respective accumulation segment, said accumulation segments being substantially parallel to each other.

Preferably said feed unit is configured in such a way as to vary, through movement of said movable portion, a respective longitudinal extension of each of said accumulation segments. Said longitudinal extension of said accumulation segments is varied simultaneously, preferably by a same quantity, and preferably keeping said accumulation segments substantially parallel to each other.

Thanks to these features it is possible to use the displacement of the movable portion to accumulate simultaneously the same quantity of strip for each of the strips forming the strip-shaped article. In this way it is possible to use a continuous feeding of the strips while nonetheless providing for steps in which the strip-shaped article is not wound.

Preferably, the winding unit is configured to receive said strip-shaped article from said outlet section.

Preferably, said feed unit comprises a convergence zone.

Preferably, said convergence zone includes a coupling roller of said plurality of strips through which said strip-shaped article is made.

Preferably, said convergence zone is comprised within said first confined zone.

Preferably, said convergence zone operates in said overpressure condition.

This provision is particularly useful to protect the convergence zone from an alteration of environmental conditions due to the presence of contaminating material in the first adjacent zone. Indeed, it must be noted that the convergence zone is typically a particularly critical zone of the apparatus for making a coil since the separator strip can be subjected to an electrostatic charge that inevitably attracts contaminating material, e.g. in the form of fine dust.

It is desirable to prevent the introduction of contaminating material between the plurality of strips during their coupling via the coupling roller in order to avoid possible malfunction and/or damage to the coil.

Preferably, the plurality of strips converges at this convergence zone by reducing the mutual distances between each strip up to the coupling roller that makes the strip-shaped article.

In this way, it is possible to optimally design the zone and process step to create the final strip-shaped article. This condition is allowed by the possibility of making independent of each other the accumulation/feeding step of the strips with respect to the coupling/convergence step.

Preferably, a strip of the plurality of strips is fed according to a direction substantially parallel to the displacement direction of the movable portion in the convergence zone.

In this way it is possible to further reduce any stresses produced on a strip in the vicinity of and during the coupling step between the strips on the coupling roller.

In at least one embodiment of the present solution, said feed unit comprises a confined suction zone configured to operate at a third pressure.

Preferably, said feed unit comprises a second, adjacent zone fluid-dynamically connected to said suction zone.

Preferably, said second adjacent zone is configured in such a way that it has a fourth pressure greater than said third pressure.

This makes it possible to divide the feed unit into at least two zones, namely the suction zone and the second adjacent zone, in which any contaminating material present in the second adjacent zone is sucked into the suction zone.

Preferably, said third pressure is the lowest pressure value in said feed unit.

Preferably, said third pressure is actuated and managed by means of suction devices positioned close to points with a higher potential density of contaminating material than in other points of said feed unit.

In this way, it is possible to remove the contaminating material from the system by effectively sucking it in, while at the same time creating the desired pressure difference conditions to produce a pressure gradient that fluid-dynamically pushes or confines the contaminating material from the second adjacent zone to the suction zone.

In at least one embodiment of the present solution, the fourth pressure is essentially equal to the second pressure.

In this way, the first adjacent zone and the second adjacent zone have essentially the same pressure, both zones being in a depression with respect to the first confined zone.

In at least one embodiment of the present solution, said first adjacent zone, configured to operate at said second pressure, comprises within it at least a second confined zone.

Preferably, said second confined zone has a fifth pressure and is configured to operate in a condition of a second overpressure with respect to said first adjacent zone.

In other words, the aforementioned fifth pressure is greater than said second pressure.

The first adjacent zone then delimits at least a second confined zone which is overpressure with respect to the first adjacent zone so as to prevent any contaminating material present in the first adjacent zone from entering the at least a second confined zone.

Preferably, the fifth pressure is equal to the first pressure.

Preferably, said at least a second confined zone is fluid-dynamically connected to said first adjacent zone.

Preferably, at least one separator winding formed by said separator strip wound in several turns is placed in said at least a second confined zone.

More preferably, two separator windings are placed in the at least a second confined zone.

Preferably, said first adjacent zone comprises two second confined zones within it.

More preferably, two separator windings are placed in respective second confined zones.

The separator strip can be subjected to an electrostatic charge that inevitably attracts the contaminating material, e.g. in the form of dust, so it is particularly important to place the separator winding in the second confined zone that operates in the second overpressure condition with respect to the first adjacent zone.

Preferably, the separator winding is comprised in a corresponding dispensing device to supply the separator strip to the corresponding inlet section of said feed unit.

Preferably, at least one separator winding is rotated to unwind the relative strip, supplying it to the feed unit and, preferably, then to the winding unit.

In at least one embodiment of the present solution, said suction zone is an ablation zone of one of said plurality of strips.

Preferably, said ablation zone is identified in correspondence of at least one corresponding laser ablation device.

Preferably, the laser ablation device is arranged to perform a removal of material from the surface of one of said plurality of strips to form a predetermined pattern on that surface.

The ablation operation of a strip can result in the production of contaminating material, such as fine dust produced by the removal of material from the strip. Therefore, the suction zone located at the laser ablation device allows for the suction of the contaminating material produced by the ablation of the strip, preventing it from reaching the second adjacent fluid-dynamic zone connected to the suction zone.

Preferably, said feed unit comprises said laser ablation device.

Preferably, at least one conductor winding formed by said conductor strip wound in several turns is placed in said second adjacent zone.

More preferably, two conductor windings are placed in the second adjacent zone.

Preferably, said conductor strip wound in several turns is an electrode and more preferably an anode.

Preferably, said conductor strip wound in several turns is an electrode and more preferably a cathode.

Preferably, the at least one conductor winding is associated with a corresponding laser ablation device.

Preferably, the conductor winding feeds a related laser ablation device.

Preferably, the conductor winding is rotated to unwind the relative strip, pushing, and thus supplying, the strip to the laser ablation device.

Preferably, the conductor winding is comprised in a corresponding dispensing device to supply the conductor strip to the corresponding inlet section of said feed unit.

Preferably, the conductor winding is rotated to unwind the relative strip, supplying it to the feed unit and, preferably, then to the winding unit.

More preferably, the conductor winding is rotated to unwind the relative strip, supplying it in succession to the laser ablation device, the feed unit and the winding unit.

In at least one embodiment of the present solution, said feed unit comprises two suction zones: a first suction zone and a second suction zone.

Preferably, said feed unit comprises two adjacent second zones: a second adjacent zone and a further second adjacent zone.

The second adjacent zone and the further second adjacent zone are fluid-dynamically connected to said first suction zone and said second suction zone respectively.

Preferably, the first suction zone and the second suction zone are respective ablation zones of one of said plurality of strips, identified at respective laser ablation devices.

Preferably, the second adjacent zone and the further second adjacent zone respectively comprise at least one conductor winding.

More preferably, the second adjacent zone comprises at least one conductor winding formed by an anode wound in several turns, while the further second adjacent zone comprises at least one conductor winding formed by a cathode wound in several turns.

In at least one embodiment of the present solution, said apparatus for making a coil comprises at least one partial confinement element.

Preferably, said partial confinement element is placed between said first adjacent zone and said first confined zone.

Preferably, said at least one partial confinement element is configured in such a way as to define several non-tight environments by inhibiting a fluid-dynamic transfer of contaminating material from said first adjacent zone to said first confined zone.

The provision of the confinement element thus makes it possible to delimit distinct environments in the apparatus for making a coil in which the transfer of contaminating material from the first adjacent zone to the first confined zone is prevented.

In at least one embodiment of the present solution, said at least one partial confinement element comprises at least one wall.

Preferably, said partial confinement element comprises at least one opening in said wall.

Preferably, said at least one opening is configured to allow the passage of at least one strip of said plurality of strips, or of said strip-shaped article, simultaneously performing a fluid-dynamic exchange between said first confined zone and said first adjacent zone.

The wall makes it possible to physically separate two zones of the apparatus for making a coil, i.e. to separate the first confined zone from the first adjacent zone.

Furthermore, the wall allows the passage of at least one strip of said plurality of strips or said strip-shaped article while preventing a transfer of contaminating material from the first adjacent zone to the first confined zone.

This allows perfected control of the fluid-dynamic exchange zone between the two zones and thus the conditions for inhibiting the transfer of contaminating material.

In addition to or as an alternative to the at least one wall, the at least one partial confinement element may comprise a device, such as an air curtain, arranged to generate a substantially laminar flow of air capable of preventing a transfer of contaminating material between the two environments.

In at least one embodiment of the present solution, said first confined zone and/or said second confined zone are provided as chambers comprising a closed box-shaped body.

Preferably, said closed box-shaped body comprises at least one of said partial confinement element placed between said first adjacent zone and said first confined zone and/or between said first adjacent zone and said second confined zone, respectively.

Preferably, the closed box-shaped body is a parallelepiped shape in which at least one of its faces comprises a partial confinement element.

More preferably, the faces of the box-shaped body consist of respective walls, at least one of which is provided with an opening allowing the passage of a strip of said plurality of strips while simultaneously creating a fluid-dynamic exchange between two adjacent zones of the apparatus for making a coil.

In at least one embodiment of the present solution, said second adjacent zone is made as a chamber preferably comprising a related closed box-shaped body.

Preferably, the closed box-shaped body of said second adjacent zone comprises a relative partial confinement element placed between said second adjacent zone and said suction zone fluid-dynamically connected to said second adjacent zone.

This partial confinement element preferably comprises a wall with an opening configured to allow the passage of one strip of said plurality of strips while simultaneously creating a fluid-dynamic exchange between said second adjacent zone and said suction zone.

In at least one embodiment of the present solution, said first confined zone and/or said first adjacent zone comprise/s pressure sensing devices.

Preferably, said pressure sensing devices are operatively connected to a processing unit.

Preferably, said processing unit is configured to achieve and/or maintain the respective pressure values of said first confined zone and/or said first adjacent zone.

Preferably, the above-mentioned pressure values are average pressure values in said first confined zone and/or in said first adjacent zone.

The pressure sensing devices can be placed at points in the first confined zone (or the first adjacent zone) equally spaced apart in order to obtain a calculation of the average pressure of the first confined zone (or the first adjacent zone) through the processing unit.

Preferably, additional pressure sensing devices are located in the at least one second confined zone and/or the at least one second adjacent zone and/or the at least one suction zone and are operatively connected to said processing unit. In this case, said processing unit is preferably further configured to achieve and/or maintain the respective pressure values of said at least one second confined zone and/or said at least one second adjacent zone and/or said at least one suction zone.

In at least one embodiment of the present solution, a pressure regulating device is arranged to control the pressure in said first confined zone and/or in said first adjacent zone and/or in said suction zone and/or in said second adjacent zone and/or in said second confined zone.

Preferably, said pressure regulating device comprises at least one gas inlet line in the first confined zone and/or in the second adjacent zone and/or in the second confined zone.

Preferably, said gas inlet line comprises at least one gas injection device configured to insert a desired amount of gas into said first confined zone and/or into said second adjacent zone and/or into said second confined zone.

Additionally or alternatively, said pressure regulating device comprises at least one gas outlet line in the first adjacent zone and/or in the suction zone.

Preferably, said gas outlet line comprises at least one suction device configured to extract a desired amount of gas from said first adjacent zone and/or from said suction zone.

Preferably, said apparatus for making a coil comprises the aforementioned pressure regulating device.

In at least one embodiment of the present solution, said apparatus for making a coil comprises at least one device for measuring the speed of an air stream.

Preferably, said measuring device is placed in correspondence of at least one opening between two adjacent zones of said apparatus that allows fluid-dynamic exchange between said adjacent zones.

Preferably said measuring device comprises an anemometer.

Preferably, said measuring device is comprised in said regulating device.

In at least one embodiment of the present solution, the method for making a coil comprises achieving and/or maintaining said overpressure in said first confined zone with respect to said first adjacent zone greater than 0.1 mbar, preferably greater than 0.5 mbar, more preferably greater than 2 mbar.

In at least one embodiment of the present solution, the method for making a coil comprises achieving and/or maintaining said overpressure in said first confined zone with respect to said first adjacent zone comprised between 0.1 and 10 mbar, preferably between 0.3 and 5 mbar, more preferably between 0.5 and 3 mbar.

In this way, it is possible to contain the development of turbulent flows by realising a substantially laminar flow condition that allows for the control of the displacement of any contaminating material, guaranteeing the correct performance of the desired industrial processes.

In at least one embodiment of the present solution, the method for making a coil comprises arranging a feed unit of said apparatus for making a coil to feed a plurality of strips to a coupling roller by means of which said strip-shaped article is made.

Preferably, said method comprises arranging a winding unit comprising at least one winding head.

Preferably, said method comprises achieving and/or maintaining said overpressure condition of said first confined zone with respect to said first adjacent zone, wherein said first confined zone comprises said winding unit.

This provision prevents any contaminating material that may be present in the first adjacent zone from polluting or otherwise altering the environment in which the winding unit is located.

In at least one embodiment of the present solution, the method for making a coil provides for the feed unit to comprise a convergence zone.

Preferably, said convergence zone includes a coupling roller of said plurality of strips through which the strip-shaped article is made.

Preferably, said convergence zone is comprised within said first confined zone, so it is in said overpressure condition.

These features prevent contaminating material that may be present in the first adjacent zone from ending up between the plurality of strips during their coupling by the coupling roller.

In at least one embodiment of the present solution, the method for making a coil comprises arranging pressure sensing devices in the first confined zone and/or the first adjacent zone.

Preferably, said method comprises arranging at least one gas inlet line in the first confined zone.

Preferably, said at least one gas inlet line comprises at least one gas injection device configured to insert a desired amount of gas into said first confined zone.

In addition to or as an alternative to said at least one gas inlet line, said method preferably includes the provision of at least one gas outlet line in said first adjacent zone.

Preferably, said at least one gas outlet line comprises at least one suction device configured to extract a desired amount of gas from said first adjacent zone.

Preferably, said method comprises operatively connecting said pressure sensing devices to a processing unit.

Preferably, said method comprises operatively connecting said at least one gas injection device and/or said at least one suction device to the processing unit.

Preferably, said method comprises realising and maintaining via the processing unit the respective pressure values of said first confined zone and/or said first adjacent zone.

The sensing devices, the at least one gas inlet line, the at least one gas outlet line and the processing unit jointly enable the regulation and maintenance of the desired pressures in the zones of interest of said apparatus for making a coil.

It should be noted that some steps of the method described above can be independent of the order of execution reported. Furthermore, some steps can be optional. Furthermore, some steps of the method can be performed repetitively, or can be performed in series or in parallel with other steps of the method.

The features and advantages of the present solution will become clearer from the detailed description of an embodiment shown, by way of non-limiting example, with reference to the appended drawings in which:

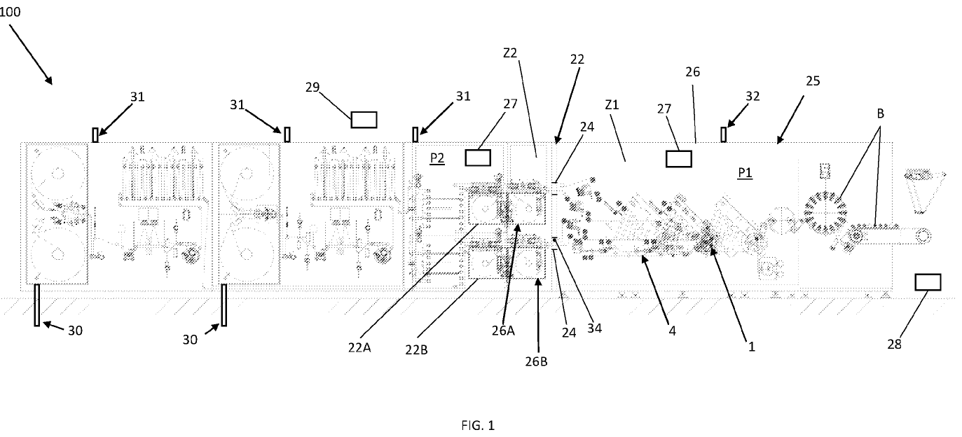

FIG. 1 is a schematic view of an apparatus for making a coil according to an embodiment of the present solution, and

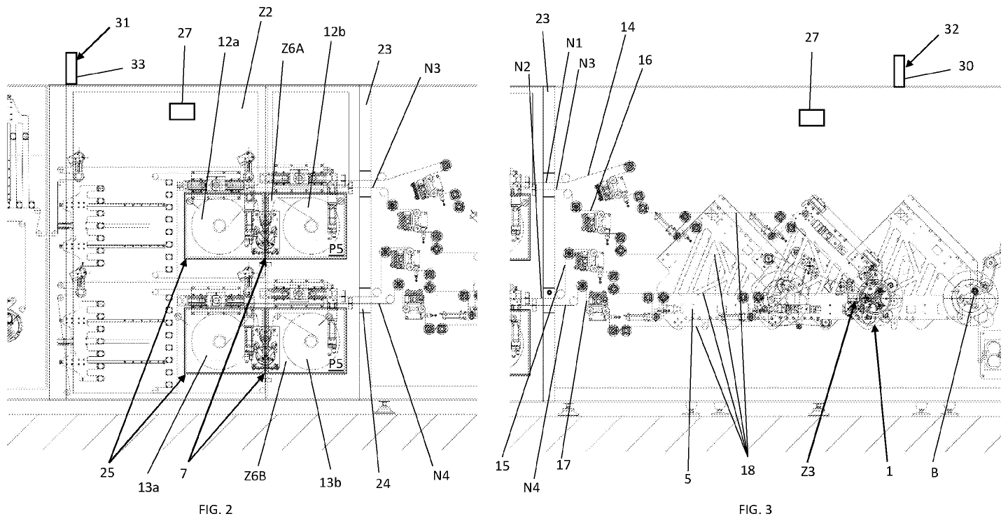

FIGS. 2-5 show details of the apparatus for making a coil of FIG. 1.

With reference to the enclosed figures, 100 denotes an apparatus for making a coil B, in particular an electrochemical cell for battery production.

With particular reference to FIGS. 1 and 2, the apparatus 100 for making a coil B comprises a first confined zone Z1 configured to operate at a first pressure P1 and comprises at least one operating unit of the apparatus 100 for making a coil B.

The apparatus 100 for making a coil B also comprises a first confined zone Z2 configured to operate at a second pressure P2 and fluid-dynamically connected to the first confined zone Z1.

The first confined zone Z1 is configured so as to operate in an overpressure condition SP1 with respect to the first adjacent zone Z2.

In the preferred embodiment shown in FIG. 1, the overpressure SP1 is 0.2 mbar or higher.

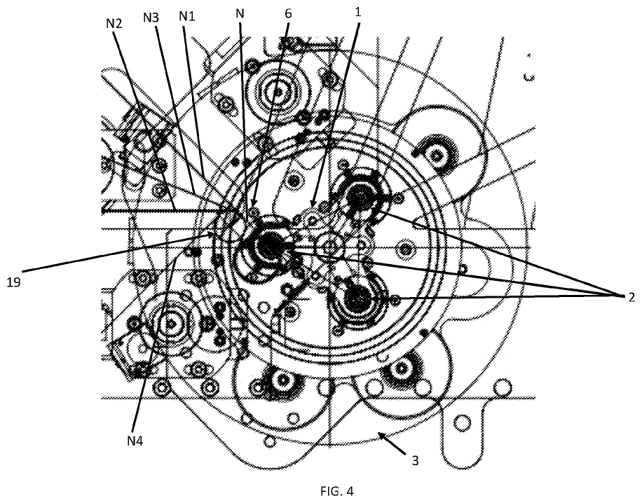

With particular reference to FIGS. 3 and 4, the operating unit is a winding unit 1 comprising a plurality of winding heads 2 configured to wind at least one strip-shaped article N in order to make a coil B.

FIG. 3 shows the operating unit under different operating conditions.

Therefore, the winding unit 1 is comprised in the first confined zone Z1 and operates in the overpressure condition SP1 with respect to the first adjacent zone Z2.

The winding unit 1 also comprises a movement device 3 of the plurality of winding heads 2 configured to displace the plurality of winding heads 2 along a working path.

In addition, the apparatus 100 for making a coil B comprises a power supply unit 4.

The power supply unit 4 is configured to feed a plurality of strips N1, N2, N3, N4 (specifically four strips) suitable for making the at least one strip-shaped article N. The plurality of strips N1, N2, N3, N4 comprises a first conductive strip N1, a second conductive strip N2, the first being a strip between anode and cathode and the second being the other, a first separator strip (electrical insulator) N3 and a second separator strip (electrical insulator) N4.

The feed unit 4 also comprises a movable portion 5 which includes an outlet section 6 through which the strip-shaped article N passes on its way out of the feed unit 4 and is fed to the winding unit 1.

The winding unit 1 is therefore configured to receive the strip-shaped article N from the outlet section 6.

The feeding unit 4 is equipped with inlet sections 7 to receive strips N1, N2, N3, N4 from respective dispensing devices.

With particular reference to FIGS. 1, 2 and 5, each dispensing device comprises a winding formed by a relative strip wound in several turns.

In detail, the apparatus 100 for making a coil B shown in FIG. 1 comprises a first pair of conductor windings 8,9 formed by respective conductor strips N2 wound in several turns, a second pair of conductor windings 10,11 formed by respective conductor strips N1 wound in several turns and four separator windings 12a, 12b, 13a, 13b formed by respective electrical insulators N3, N4. With particular reference to FIGS. 3 and 4, respective feed paths 14, 15, 16, 17 are defined for each strip N1, N2, N3, N4.

These feed paths 14, 15, 16, 17 comprise a respective accumulation section 18, the accumulation sections 18 being preferably substantially parallel to each other.

The feed unit 4 is configured in such a way as to vary, by movement of said movable portion 5, a respective longitudinal extension of each of the accumulation sections 18. Specifically, the longitudinal extension of the accumulation sections 18 is varied simultaneously, preferably by the same amount, keeping the accumulation sections 18 essentially parallel to each other.

With particular reference to FIGS. 3 and 4, the feed unit 4 comprises a convergence zone Z3 which includes a coupling roller 19 of the plurality of strips N1, N2, N3, N4 by means of which the strip-shaped article N is made. The convergence zone Z3 is comprised in the first confined zone Z1 and therefore operates in the above-mentioned overpressure condition SP1.

It should be noted that the strips N1, N2, N3, N4 of the apparatus 100 for making a coil B converge at the convergence zone Z3, reducing the mutual distances to the coupling roller 19.

Preferably, the strips N1, N2, N3, N4 are fed according to a direction substantially parallel to the direction of movement of the movable portion 5 in the convergence zone Z3.

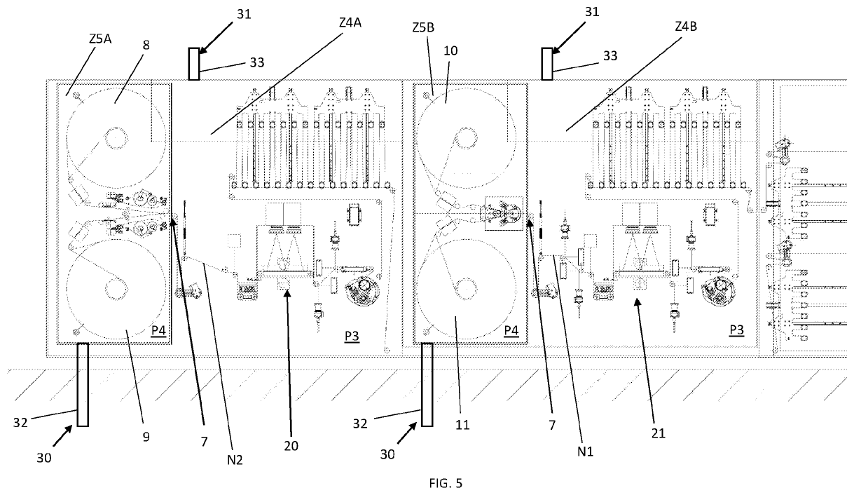

With particular reference to FIG. 5, the feed unit 4 comprises a first suction zone Z4A and a second suction zone Z4B confined and configured to operate at a third pressure P3as well as a second adjacent zone Z5A and a further second adjacent zone Z5B fluid-dynamically connected to the first suction zone Z4A and the second suction zone Z4B, respectively.

The second adjacent zones Z5A, Z5B are configured so that the fourth pressure P4 is greater than the third pressure P3, the fourth pressure P4 being preferably substantially equal to the second pressure P2.

In detail, the second adjacent zone Z5A comprises the first pair of conductor windings 8,9 formed by respective conductor strips N2 wound in multiple turns, while the further second adjacent zone Z5B comprises the second pair of conductor windings 10,11 formed by respective conductor strips N1 wound in multiple turns.

The two suction zones Z4A, Z4B are ablation zones of respective conductor strips N1 and N2. The ablation zones are identified at the respective laser ablation devices 20, 21.

At least one winding of the first pair of conductor windings 8,9 is associated with the laser ablation device 20 of the first suction zone Z4A while at least one winding of the second pair of conductor windings 10, 11 is associated with the laser ablation device 21 of the second suction zone Z4B.

Therefore, the conductor windings associated with the laser ablation devices 20,21 are rotated to unwind the respective strip, supplying it, in succession, to the respective laser ablation devices 20,21, the feed unit 4 and the winding unit 1.

With particular reference to FIG. 2, the first adjacent zone Z2 comprises within it at least a second confined zone. In particular, the first adjacent zone Z2 comprises within it a second adjacent zone Z6A and a further second adjacent zone Z6B.

The second confined zones Z6A, Z6B have a fifth pressure P5 and are configured to operate in a condition of a second overpressure SP2 with respect to said first confined zone Z2, the fifth pressure P5 being substantially equal to the first pressure P1.

The second confined zones Z6A, Z6B are fluid-dynamically connected to the first adjacent zone Z2.

In detail, the second confined zone Z6A comprises a first pair of separator windings 12a, 12b and the further second confined zone Z6B comprises a second pair of separator windings 13a, 13b. At least one separator winding of the first pair of separator windings 12a, 12b is rotated to unwind the respective strip, supplying it to the feed unit and subsequently to the winding unit. In addition, at least one separator winding of the second of the pair of separator windings 13a, 13b is rotated to unwind the respective strip, supplying it to the feed unit 4 and subsequently to the winding unit 1.

The apparatus 100 for making a coil B comprises a partial confinement element 22. In particular, the partial confinement element 22 is placed between the first adjacent zone Z2 and the first confined zone Z1 and is configured in such a way as to define several non-tight environments by inhibiting a fluid-dynamic transfer of contaminating material from the first adjacent zone Z2 to the first confined zone Z1.

With particular reference to FIGS. 2 and 3, the partial confinement element 22 comprises at least one wall 23 provided with at least one opening 24 configured to allow the passage of at least one strip of the plurality of strips N1, N2, N3, N4, simultaneously creating a fluid-dynamic exchange between the first confined zone Z1 and the first adjacent zone Z2.

With reference now to the first confined zone Z1 and the second confined zones Z6A, Z6B, they are made as chambers 25 comprising a relative enclosed box-shaped body.

The closed box-shaped body 26 relating to the first confined zone Z1 comprises a partial confinement element 22 located between the first adjacent zone Z2 and the first confined zone Z1. In contrast, the two closed box-shaped bodies 26A, 26B relating to the second confined zones Z6A, Z6B each comprise a relative partial confinement element 22A,22B located between the first adjacent zone Z2 and the second confined zone Z6A and, respectively, between the first adjacent zone Z2 and the further second confined zone Z6B.

The apparatus 100 for making a coil B shown in the figures also comprises pressure sensing devices 27 placed in both the first confined zone Z1 and the first adjacent zone Z2 and operatively connected to a processing unit 28.

The processing unit 28 is configured to achieve and/or maintain the respective pressure values of the first confined zone Z1 and the first adjacent zone Z2.

Further pressure sensing devices 27 are located in the second confined zones Z6A, Z6B, the second adjacent zones Z5A, Z5B and the suction zones Z4A, Z4B and are operatively connected to the processing unit 28. Therefore, the processing unit 28 is further configured to achieve and/or maintain the respective pressure values of the aforesaid zones Z4A, Z4B, ZSA, Z5B and Z6A, Z6B.

The apparatus 100 for making a coil B also comprises pressure regulating device 29.

The pressure regulating device 29 is designed to influence the pressure in the first confined zone Z1, the first adjacent zone Z2, the suction zones Z4A, Z4B, the second adjacent zones Z5A, Z5B and the second confined zones Z6A, Z6B.

In detail, the pressure regulating device 29 comprises gas inlet lines 30 in the first confined zone Z1, in the second adjacent zones Z5A, Z5B and in the second confined zones Z6A, Z6B, as well as gas outlet lines 31 in the first adjacent zone Z2 and in the suction zones Z4A, Z4B.

The gas inlet lines 30 comprise at least one gas injection device 32 configured to inject a desired amount of gas into the first confined zone Z1, into the second adjacent zones Z5A, Z5B and into the second confined zones Z6A, Z6B while the gas outlet lines 31 comprise at least one suction device 33 configured to extract a desired amount of gas from the first adjacent zone Z2 and the suction zones Z4A, Z4B.

The apparatus 100 for making a coil B also comprises a measuring device 34 for measuring the speed of an air flow, the measuring device 34 being located at the opening 24 of the wall 23.

Specifically, the measuring device 34 comprises an anemometer.

A method for making a coil B, preferably for an electrochemical cell intended for battery production, the coil B being made by winding a strip-shaped article N, involves the steps of arranging the apparatus 100 for the making a coil B and achieving an operating condition of overpressure SP1 in the first confined zone Z1 with respect to the first adjacent zone Z2.

The method can include the step of achieving and/or maintaining the overpressure SP1 in the first confined zone Z1 relative to the first adjacent zone Z2 comprised between 0.2 and 0.5 mbar. Additionally or alternatively, the method may comprise the steps of: arranging the feed unit 4 of the apparatus 100 for making a coil B to feed the plurality of strips N1, N2, N3, N4 to the coupling roller 19 by means of which the strip-shaped article N is made; arranging the winding unit 1; and achieving and/or maintaining the overpressure condition SP1 of the first confined zone Z1 with respect to the first adjacent zone Z2, wherein the first confined zone Z1 comprises the winding unit 1.

Additionally or alternatively, the method may comprise the steps of: arranging pressure sensing devices 27 in the first confined zone Z1 and/or in the first adjacent zone Z2; arranging at least one gas inlet line 30 in the first confined zone Z1, the at least one gas inlet line 30 comprising at least one gas injection device 32 configured to insert a desired amount of gas into the first confined zone Z1; providing at least one gas outlet line 32 in the first adjacent zone Z2, the at least one gas outlet line 31 comprising at least one suction device 33 configured to extract a desired amount of gas from the first adjacent zone Z2; operatively connecting the pressure sensing devices 27 to the processing unit 28; operatively connecting the at least one gas injection device 31 and the at least one suction device 33 to the processing unit 28; and achieving and maintaining via the processing unit 28 the respective pressure values of the first confined zone Z1 and the first adjacent zone Z2. A further method for realising a coil B, preferably for an electrochemical cell intended for battery production, the coil B being realised by winding a strip-shaped article N, comprises the steps of arranging the apparatus 100 for making a coil B and achieving an operating condition of depression DP1 in the first adjacent zone Z2 with respect to the first confined zone Z1 in such a way as to hinder the entry of contaminating material into the first confined zone Z1 from the first adjacent zone Z2 and/or to promote the entry of contaminating material into the first adjacent zone Z2 from the first confined zone Z1.

1. An apparatus for making a coil for an electrochemical cell for battery production, comprising:
a first confined zone configured to operate at a first pressure and comprising at least one operating unit of said apparatus for making a coil, and
a first adjacent zone configured to operate at a second pressure and fluid-dynamically connected to said first confined zone,
wherein said first confined zone is configured so as to operate in an overpressure condition with respect to said first adjacent zone.

2. The apparatus for making a coil according to claim 1, wherein said overpressure is greater than 0.1 mbar, preferably greater than 0.5 mbar, more preferably greater than 2 mbar.

3. The apparatus for making a coil according to claim 1, comprising:
a winding unit including at least one winding head configured to wind at least one strip-shaped article so as to make said coil,
wherein said winding unit is comprised in said first confined zone and operates at said overpressure condition with respect to said first adjacent zone.

4. The apparatus for making a coil according to claim 3, comprising a feed unit configured to feed a plurality of strips suitable for making said at least one strip-shaped article, said plurality of strips comprising at least one conductive strip and/or one separator strip, wherein said feed unit comprises a convergence zone including a coupling roller of said plurality of strips by means of which said strip-shaped article is made, said convergence zone being comprised in said first confined zone and operating in said overpressure condition.

5. The apparatus for making a coil according to claim 4, wherein said feed unit comprises
a suction zone confined and configured to operate at a third pressure,
a second adjacent zone fluid-dynamically connected to said suction zone and configured in such a way as to have a fourth pressure greater than said third pressure.

6. The apparatus for making a coil according to claim 5, wherein said fourth pressure is substantially equal to said second pressure.

7. The apparatus for making a coil according to claim 3, wherein said first adjacent zone, configured to operate at said second pressure, comprises therein at least one second confined zone having a fifth pressure and configured to operate in a condition of a second overpressure with respect to said first adjacent zone.

8. The apparatus for making a coil according to claim 5, wherein said suction zone is an ablation zone of one of said plurality of strips, identified in correspondence of at least one relative laser ablation device.

9. The apparatus for making a coil according to claim 4, comprising at least one partial confinement element placed between said first adjacent zone and said first confined zone, wherein said at least one partial confinement element is configured to define several non-tight environments inhibiting a fluid-dynamic transfer of contaminating material from said first adjacent zone to said first confined zone.

10. The apparatus for making a coil according to claim 9, wherein said at least one partial confinement element comprises
at least one wall,
at least one opening of said wall,
said at least one opening being configured to allow the passage of at least one strip of said plurality of strips or of said strip-shaped article, simultaneously performing a fluid-dynamic exchange between said first confined zone and said first adjacent zone.

11. The apparatus for making a coil according to claim 7, wherein said first confined zone and/or said second confined zone are made as chambers comprising a closed box-shaped body comprising at least one of said partial confinement element placed respectively between said first adjacent zone and said first confined zone and/or between said first adjacent zone and said second confined zone.

12. The apparatus for making a coil according to claim 1, wherein said first confined zone and/or said first adjacent zone comprise/s pressure sensing devices operatively connected to a processing unit configured to achieve and/or maintain the respective pressure values of said first confined zone and/or said first adjacent zone.

13. The apparatus for making a coil according to claim 1, comprising at least one measuring device of the speed of an air flow, said measuring device being preferably located in correspondence to at least one opening between two adjacent zones of said apparatus allowing a fluid-dynamic exchange between said adjacent zones.

14. A method for making a coil for an electrochemical cell for battery production, said coil being made by winding a strip-shaped article, said method comprising:
arranging an apparatus for making a coil comprising a first confined zone comprising at least one operating unit of said apparatus for making a coil,
creating an operating overpressure condition in said first confined zone with respect to a first adjacent zone fluid-dynamically connected to said first confined zone so as to hinder the entry of contaminating material into said first confined zone from said first adjacent zone.

15. The method for making a coil, according to claim 14, comprising:
achieving and/or maintaining said overpressure greater than 0.1 mbar, preferably greater than 0.5 mbar, more preferably greater than 2 mbar.

16. The method for making a coil, according to claim 14, comprising:
arranging a feed unit of said apparatus for making a coil to feed a plurality of strips to a coupling roller by means of which said strip-shaped article is made,
arranging a winding unit comprising at least one winding head,
achieving and/or maintaining said overpressure condition of said first confined zone with respect to said first adjacent zone wherein said first confined zone comprises said winding unit.

17. The method for making a coil according to claim 16, wherein said feed unit comprises a convergence zone including a coupling roller of said plurality of strips by means of which said strip-shaped article is made, said convergence zone being comprised in said first confined zone and thus in said overpressure condition.

18. The method for making a coil according to claim 14, comprising
arranging pressure sensing devices in said first confined zone and/or in said first adjacent zone,
arranging
at least one gas inlet line in said first confined zone, comprising at least one gas injection device configured to insert a desired amount of gas into said first confined zone, and/or
at least one gas outlet line in said first adjacent zone, comprising at least one suction device, configured to extract a desired amount of gas from said first adjacent zone,
operatively connecting said pressure sensing devices to a processing unit,
operatively connecting said at least one gas injection device and/or said at least one suction device to said processing unit,
achieving and maintaining via said processing unit the respective pressure values of said first confined zone and/or said first adjacent zone.

19. A method for making a coil for an electrochemical cell for battery production, said coil being made by winding a strip-shaped article, said method comprising:
arranging an apparatus for making a coil comprising a first confined zone, comprising at least one operating unit of said apparatus for making a coil, and a first adjacent zone fluid-dynamically connected to said first confined zone,
achieving a depression operating condition in said first adjacent zone with respect to said first confined zone so as to hinder the entry of contaminating material into said first confined zone from said first adjacent zone and/or to ease the entry of contaminating material into said first adjacent zone from said first confined zone.
